(19) United States
(12) Patent Application Publication
(10) Pub. No.: US 2014/0317099 A1
(43) Pub. Date: Oct. 23, 2014

(54) PERSONALIZED DIGITAL CONTENT SEARCH

(71) Applicant: GOOGLE INC., (US)

(72) Inventors: Ankit Jain, Milpitas, CA (US); Wei Chai, Union City, CA (US); Piotr Zielinski, Brookline, MA (US); Qisheng Zhao, Sunnyvale, CA (US); Jindong Chen, Hillsborough, CA (US); Anna Patterson, Saratoga, CA (US); Ulas Kirazci, Mountain View, CA (US); Abhinav Khandelwal, Mumbai Maharashtra (IN)

(73) Assignee: GOOGLE INC., Mountain View, CA (US)

(21) Appl. No.: 13/868,533

(22) Filed: Apr. 23, 2013

(51) Int. Cl. G06F 17/30

(52) U.S. Cl. CPC G06F 17/3053
USPC 707/723

(57) ABSTRACT

Systems and method are disclosed personalizing search results. An example method for personalizing search results may include receiving from a user, a search query for a media item, identifying search results for the search query, and generating a score for each of a plurality of media items identified in the search results. The score for a corresponding one of the plurality of media items may be based on the search query and one or both of a personalized query independent score and/or a personalized query dependent score. The at least one personalized query independent and query dependent scores may be based on at least one media preference signal associated with the user. The search results may be ranked based on the generated score for each of the plurality of media items.

### BACKGROUND

An information retrieval system uses terms and phrases to index, retrieve, organize and describe documents. When a user enters a search query, the terms in the query are identified and used to retrieve documents from the information retrieval system, and then rank them. However, conventional search systems are rarely personalized and provide the same search results to all users. Additionally, in digital content information retrieval systems, such as book, music or other media search engines, there is often not enough data per document to score documents effectively in the context of browse queries. Consequently, searches in such digital content information retrieval systems may result in ambiguous scoring of the documents associated with the search terms and phrases, which leads to non-optimal ranking of the search results.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for personalized digital content search, substantially as shown in and/or described in connection with at least one of the figures, as set forth more completely in the claims.

These and other advantages, aspects and features of the present disclosure, as well as details of illustrated implementation(s) thereof, will be more fully understood from the following description and drawings.

In accordance with an example embodiment of the disclosure, a method for personalizing search results may include receiving from a user a search query for a media item, identifying search results for the search query, and generating a score for each of a plurality of media items identified in the search results. The score for a corresponding one of the plurality of media items may be based on a score dependent on the search query and one or both of at least one personalized query independent score and/or at least one personalized query dependent score. The at least one personalized query independent and query dependent scores may be based on at least one media preference signal associated with the user. The search results may be ranked based on the generated score for each of the plurality of media items. The media item may include a video, a movie, a TV show, a book, an audio recording, a device application (app), a music album and/or another digital media item.

In accordance with another example embodiment of the disclosure, a system for personalizing search results may include a network device (e.g., the search engine 102, with a CPU 103 and memory 105, as illustrated in FIG. 1A). The network device may be operable to receive from a user a search query for a media item, identify search results for the search query, and generate a score for each of a plurality of media items identified in the search results. The score for a corresponding one of the plurality of media items may be based on a score dependent on the search query and one or both of at least one personalized query independent score and/or at least one personalized query dependent score. The at least one personalized query independent and query dependent scores may be based on at least one media preference signal associated with the user. The search results may be ranked based on the generated score for each of the plurality of media items.

In accordance with yet another example embodiment of the disclosure, a machine-readable storage device, having stored thereon a computer program having at least one code section for personalizing search results may be disclosed. The at least one code section may be executable by a machine for causing the machine to perform a method including receiving from a user a search query for a media item, identifying search results for the search query, and generating a score for each of a plurality of media items identified in the search results. The score for a corresponding one of the plurality of media items may be based on a score dependent on the search query and one or both of at least one personalized query independent score and/or at least one personalized query dependent score. The at least one personalized query independent and query dependent scores may be based on at least one media preference signal associated with the user. The search results may be ranked based on the generated score for each of the plurality of media items.

### BRIEF DESCRIPTION OF SEVERAL VIEWS OF THE DRAWINGS

FIG. 1A is a block diagram illustrating an example information retrieval system, in accordance with an example embodiment of the disclosure.

FIG. 1B is a block diagram of an example implementation of a query-independent scores module using signals in the search corpus, in accordance with an example embodiment of the disclosure.

FIG. 1C is a block diagram of an example implementation of a personalized query-dependent scores module, in accordance with an example embodiment of the disclosure.

FIG. 2 is a block diagram of an example implementation of a personalized query-independent scores module which may be used in a books search engine, in accordance with an example embodiment of the disclosure.

FIG. 3 is a block diagram of an example implementation of a personalized query-independent scores module which may be used in a movies/shows search engine, in accordance with an example embodiment of the disclosure.

FIG. 4 is a block diagram of an example implementation of a personalized query-independent scores module which may be used in a music search engine, in accordance with an example embodiment of the disclosure.

FIG. 5 is a block diagram of an example implementation of a personalized query-independent scores module which may be used in an applications (apps) search engine, in accordance with an example embodiment of the disclosure.

FIG. 6 is a flow chart illustrating example steps of a method for personalizing search results, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations.

As used herein, the term “corpus” (plural, “corpora”) means a collection of documents (or data items) of a given type. As used herein, the term “WWW-based search corpora” or “WWW-based corpora” is corpora meant to include all documents available on the Internet (i.e., including, but not limited to, music-related documents, book-related documents, movie-related documents and other media-related documents). The term “non-WWW corpus” or “non WWW-based corpus” means a corpus where the corpus documents (or data items) are not available on the Internet.

The term “small” corpora may indicate corpora including at least one corpus that is a subset of WWW-based (or web-based) corpora, or at least one corpus that is partially or completely non-overlapping with the web-based corpora. An example of “small” corpora may include corpora associated with an online media search engine. The “small” corpora may include, for example, a movie corpus (associated with a movie search engine), music corpus (associated with a music search engine), etc. Additionally, portions of the music and/or movies database may be available via an Internet search of the WWW-based corpora (i.e., such portions of the respective corpus are a subset of the WWW-based corpora), while other portions of the “small” corpora may not be available on the WWW-based corpora and are, therefore, non-overlapping with the WWW-based corpora. The term “non-overlapping corpus” (e.g., a first corpus is non-overlapping with a second corpus), means that documents that may be found in one corpus, may not be found in the other corpus.

As used herein the term “media” or “digital media” refers to any type of digital media documents (or items) available for purchase/download and consumption by a user. Non-limiting examples of digital media include videos, movies, TV shows, books, magazines, newspapers, audio recordings, music albums, comics, and other digital media.

An information retrieval system may use terms and phrases to index, retrieve, organize and describe documents. Terms in a query may be identified and used to retrieve and rank documents. Search queries may be broken into two categories—navigational and browse/informational. Navigational queries are detailed queries that are clear about a user's intent, while browse queries include queries that are discovery oriented. An example navigational query, in the context of a Book Search Engine, may be “Fifty Shades of Grey”. A browse query in this same context may be “romance novel”. In example digital content information retrieval systems, such as Book search engines (or other types of digital media search engines, such as movies, shows, apps, music), there is often insufficient data per document to score documents effectively in the context of browse queries. An example navigational query, in the context of a Mobile Application Search Engine, may be “Spotify.” A browse query in this same context may be “free games.” An example navigational query, in the context of a Music Search Engine, may be “Lady Gaga Bad Romance.” A browse query in this same context may be “dance music.” An example navigational query, in the context of Movie & TV Search Engine, may be “Harry Potter & the Prisoner of Azkaban.” A browse query in this same context may be “action movies.”

The systems and methods described herein may be used to improve the quality of the browse queries in a digital content information retrieval system. For example, retrieved documents may be scored using both query-dependent and query-independent scores. The query-independent scores may include scores that are based on signals within the corresponding document corpus, as well as personalized query-independent scores based on signals associated with the user (e.g., user's demographics, location, prior viewing/purchase history, user reviews, signals from user social circles, etc.).

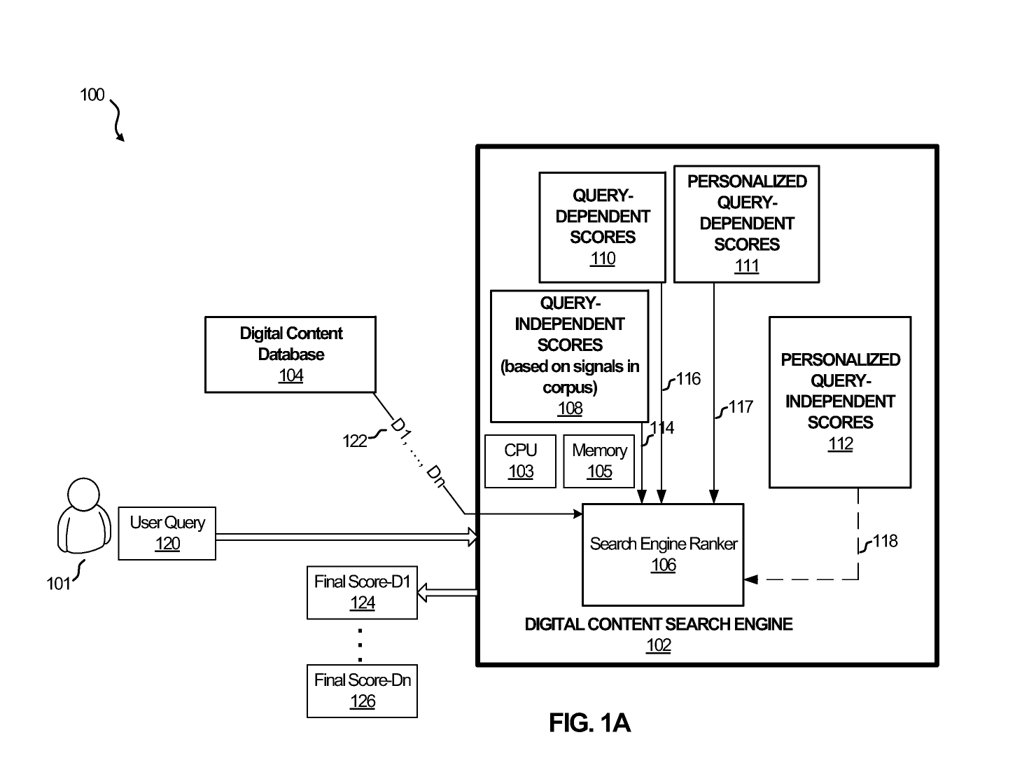

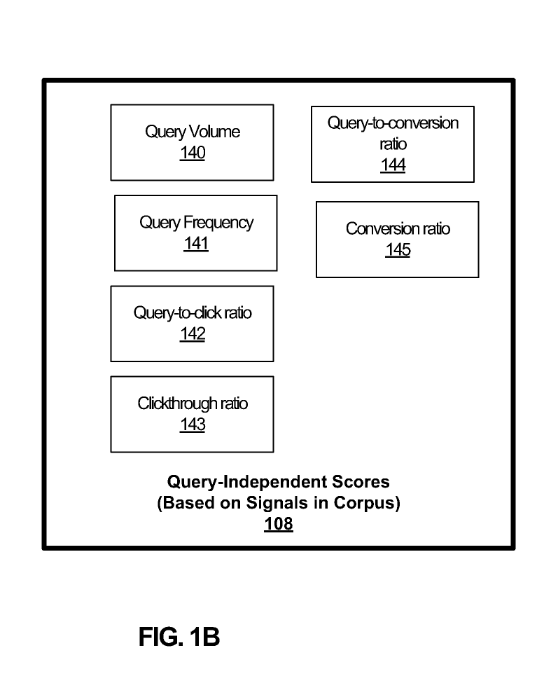

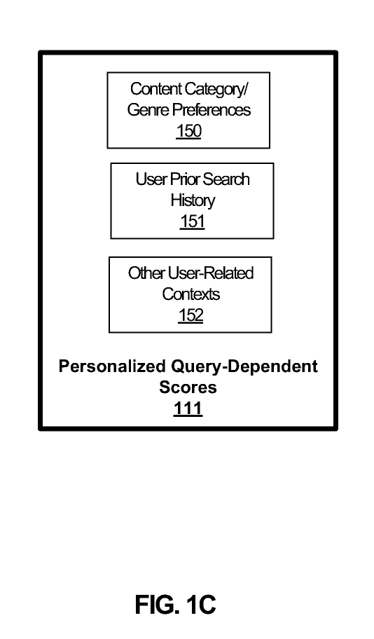

FIG. 1A is a block diagram illustrating an example information retrieval system, in accordance with an example embodiment of the disclosure. Referring to FIG. 1A, the example information retrieval system 100 may comprise a digital content search engine 102 and a digital content database (or corpus) 104.

The digital content database 104 may comprise suitable circuitry, logic and/or code and may be operable to provide documents of a specific type (e.g., music, videos, books, movies, TV shows, apps, etc.). The digital content database 104 may comprise a “small” corpora (e.g., as defined herein above).

The digital content search engine 102 may comprise suitable circuitry, logic and/or code and may be operable to receive database documents (e.g., documents 122, D1, . . . , Dn) in response to a user query 120 from user 101, and rank the received documents 122 based on the document final scores 124, . . . , 126. The digital content search engine 102 may comprise a CPU 103, a memory 105, a query-independent scores module 108, a query-dependent scores module 110, a personalized query-dependent scores module 111, a personalized query-independent scores module 112, and a search engine ranker 106.

The query-independent scores module 108 may comprise suitable circuitry, logic and/or code and may be operable to calculate a query-independent score 114 (e.g., a popularity score) for one or more documents received from the database 104. The query-independent score 114 may be based on signals in the corpus associated with database 104. For example, the query-independent score 114 may comprise a popularity score based on the number of search queries previously received within the search engine 102 about a specific document from the database 104. The query-independent score 114 may also comprise other types of signals, such as query-to-click ratio information and clickthrough ratio (CTR) information for at least one web page search result for the specific document. Additional signals associated with the query-independent scores module 108 are illustrated in FIG. 1B.

The query-dependent scores module 110 may comprise suitable circuitry, logic and/or code and may be operable to generate a score 116 for one or more of the documents 122, based on terms in the user query 120.

The personalized query-dependent scores module 111 may comprise suitable circuitry, logic and/or code and may be operable to generate a personalized query-dependent score 117 by combining information about the user's interests (based on collected data, such as user's content category/genre preferences, user's prior search history, location such as work/at home/traveling/driving, or any other user-related context) with the query at hand (e.g., query 120). For example, if the user query 120 is “games” and the search engine 102 includes user-related information that user 101 likes board games, then the personalized query-dependent score 117 may boost the scoring of results that are relevant to board games. More specific examples of personalized query-dependent scores are illustrated in reference to FIG. 1C.

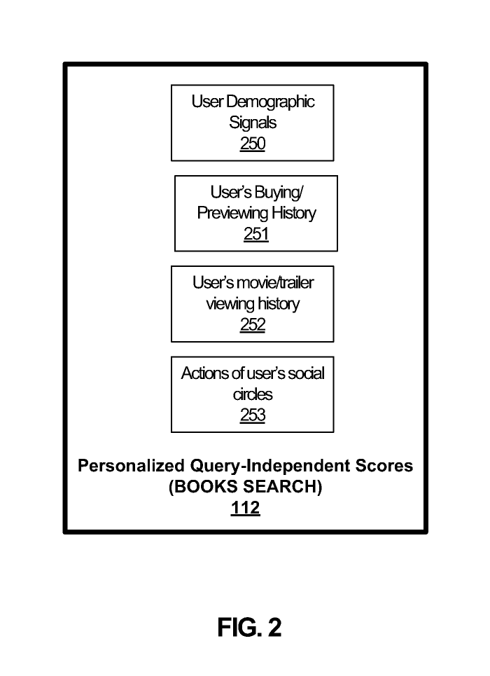

The personalized query-independent scores module 112 may comprise suitable circuitry, logic and/or code and may be operable to generate a query-independent score 118 based on one or more signals associated with the user 101 (e.g., user's demographics, location, prior viewing/purchase history, user reviews, signals from user social circles, etc.). More specific examples of personalized query-independent scores are illustrated in reference to FIGS. 2-5.

The search engine ranker 106 may comprise suitable circuitry, logic and/or code and may be operable to receive one or more documents 122 (e.g., documents D1, . . . , Dn) in response to a user query 120. The search engine ranker 106 may then rank the received documents 122 based on a final ranking score 124, . . . , 126 calculated for each document using one or more of the query-independent score 114 (received from the query-independent scores module 108), the query-dependent score 116 (received from the query-dependent scores module 110), the personalized query-dependent score 117 (received from the personalized query-dependent scores module 111), and/or one or more personalized query-independent scores (e.g., received from the personalized query-independent scores module 112).

In operation, the digital content search engine 102 may receive a document query 120 from user 101. After the search engine 102 receives the user query 120, the search engine 102 may obtain one or more documents 122 (D1, . . . , Dn) that satisfy the user query 120. After the search engine 102 receives the documents 122, a query-independent score 114 (using signals in the corpus associated with database 104) and a query-dependent score 116 may be calculated for each of the documents. Additionally, the search engine 102 may utilize a personalized query-independent scores module 112 and personalized query-dependent scores module 111 (implemented as part of the search engine 102 or separately) to receive a personalized query-independent score 118 and a personalized query-dependent score 117, respectively. The search engine ranker 106 may then use the scores 114, 116, 117, and 118 to calculate the final ranking scores 124, . . . , 126 for the documents 122, and output a ranked document search results list back to the user 101.

Even though the search engine 102 and the database 104 are all illustrated as separate blocks, the present disclosure may not be limited in this regard. More specifically, the database 104 may be part of, and implemented within, the search engine 102 with all processing functionalities being controlled by the CPU 103. The CPU 103 may be operable to perform one or more of the processing functionalities associated with retrieving and/or scoring of documents, as disclosed herein. Additionally, the digital content search engine may be associated with various types of digital media items, such as books, videos, TV Shows, movies, music, apps, and/or any other kind of digital media.

FIG. 1B is a block diagram of an example implementation of a query-independent scores module using signals in the search corpus, in accordance with an example embodiment of the disclosure. Referring to FIG. 1B, the query-independent scores module 108 may comprise suitable circuitry, logic and/or code and may be used to communicate one or more query-independent scores 114 for a given document, where the scores may be based on WWW signals for search results in a WWW-based portion of the “small” corpora associated with database 104. The query-independent scores may be used by the search engine ranker 106 to generate the final ranking scores 124, . . . , 126 of documents 122, D1, . . . , Dn. More specifically, the query-independent scores module 108 may comprise a query volume module 140, a query frequency module 141, a query-to-click ratio module 142, and a clickthrough ratio (CTR) module 143.

The query volume module 140 and the query frequency module 141 may comprise suitable circuitry, logic and/or code and may be operable to provide scores associated with query volume and query frequency, respectively, of searches performed within a web-based information corpus. The query-to-click ratio module 142 and the click-through ratio module 143 may comprise suitable circuitry, logic and/or code and may be operable to provide scores associated with query-to-click ratios and click-through ratios, respectively, of web page search results for queries performed within the “small” corpora associated with database 104. The query-to-conversion ratio module 144 and the conversion ratio module 145 may comprise suitable circuitry, logic and/or code and may be operable to provide scores associated with query-to-conversion ratio and conversion ratio, respectively, of searches performed within the corpus associated with the database 104

Even though only six query-independent scores modules 140-145 (using corpus signals) are listed with regard to the query-independent scores module 108, the present disclosure is not limiting in this regard, and other query-independent scores may also be utilized by the search engine 102 in generating the final ranking scores 124, . . . , 126.

FIG. 1C is a block diagram of an example implementation of a personalized query-dependent scores module, in accordance with an example embodiment of the disclosure. Referring to FIG. 1C, the personalized query-dependent scores module 111 may generate the personalized query-dependent score 117 based on content category/genre preferences 150, prior search history 151 and/or any other user-related contexts 152 associated with the user 101 (e.g., user current location, etc.).

FIG. 2 is a block diagram of an example implementation of a personalized query-independent scores module which may be used in a books search engine, in accordance with an example embodiment of the disclosure. Referring to FIGS. 1A-2, in instances when the digital content search engine 102 comprises a book search engine, the personalized query-independent scores module 112 may use signals from, e.g., a recommendation engine. Such signals may include books popular in a user's demographic, books related to books a user has previously bought, books in the categories/genres a user has shown interest in, as well as books that are recommended (liked or +1′d) by a user's social circles in order to improve the quality of search results of the search engine 102.

The personalized query-independent scores module 112 may generate a query-independent score based on user demographic signals 250, user's buying/previewing history 251, user's movie/trailer viewing history 252, and signals 253 associated with user's social circles.

For example, based on a user's past purchases/previews, the search engine 102 may determine the categories/genres of books the user is interested in, which information may be used by the ranker 106 to boost the score for books/series in these genres.

Based on a user's demographics, the ranker 106 may score higher and promote books that are popular in the age/gender groups that the user belongs to.

Based on the trailers/movies a user has watched/purchased, the ranker 106 may score higher books that inspired the movies as well as books of similar topics and books by the same or similar author.

Based on the actions of a user's social circle (purchases and/or +1/likes), the ranker 106 may score higher books that the user might also like (e.g., books purchased by the user's social circle friends).

Even though only four query-independent scores modules 250-253 are listed with regard to the personalized query-independent scores module 112, the present disclosure is not limiting in this regard, and other query-independent scores may also be utilized by the search engine 102 in generating the final ranking scores 124, . . . , 126.

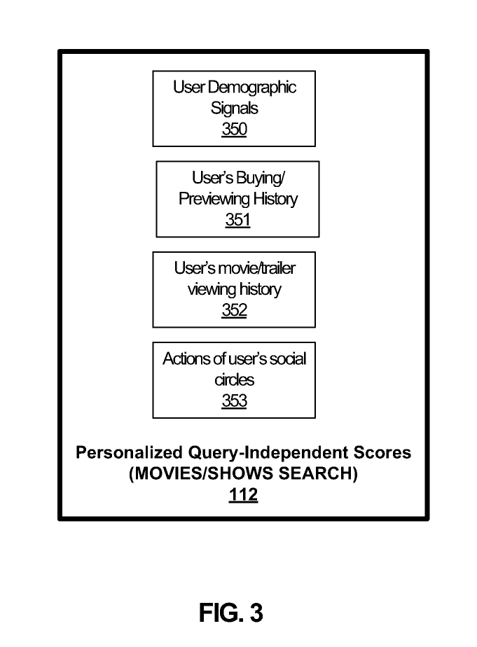

FIG. 3 is a block diagram of an example implementation of a personalized query-independent scores module which may be used in a movies/shows search engine, in accordance with an example embodiment of the disclosure. Referring to FIGS. 1A-3, in instances when the digital content search engine 102 comprises a movies/shows search engine, the personalized query-independent scores module 112 may use signals from, e.g., a recommendation engine. Such signals may include movies based on the trailers a user has watched on related sites, movies related to other movies/shows that the user has already purchased, and movies purchased and/or recommended by a user's social circles in order to improve the quality of search results of the search engine 102.

The personalized query-independent scores module 112 may generate a query-independent score based on user demographic signals 350, user's buying/previewing history 351, user's movie/trailer viewing history 352, and signals 353 associated with user's social circles.

For example, based on a user's past purchases/views (not limited to purchases of movies), the search engine 102 may determine the kind of movies the user 101 may be interested in, including movie genres, languages, topics, which information may be used by the ranker 106 to boost the score of movies that match the user's interests.

Based on a user's viewing history, the ranker 106 may score higher movies whose trailers the user has previously watched. In this regard, the user's viewing/watch history may be used to derive information about the long-term interests of the user, as well as to support real-time response to the user's behavior (e.g., watching a movie trailer minutes ago can trigger different search results with the corresponding movie showing on the top).

Based on the actions of a user's social circle (purchases and/or +1/likes), the ranker 106 may score higher movies that this user might also like (e.g., movies purchased by the user's social circle friends).

Even though only four query-independent scores modules 350-353 are listed with regard to the personalized query-independent scores module 112, the present disclosure is not limiting in this regard, and other query-independent scores may also be utilized by the search engine 102 in generating the final ranking scores 124, . . . , 126.

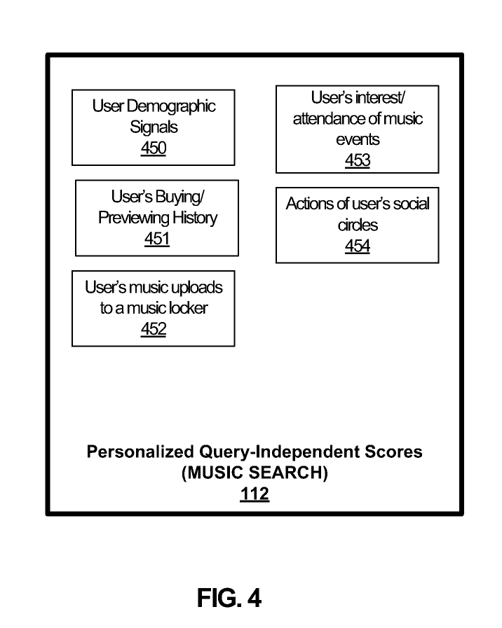

FIG. 4 is a block diagram of an example implementation of a personalized query-independent scores module which may be used in a music search engine, in accordance with an example embodiment of the disclosure. Referring to FIGS. 1A-4, in instances when the digital content search engine 102 comprises a music search engine, the personalized query-independent scores module 112 may use signals from, e.g., a recommendation engine. Such signals may include tracks/songs based on the music video a user has watched, tracks/songs that are on the soundtrack of a movie a user has purchased, songs that are similar in audio qualities to others that the user has already purchased, and tracks/songs purchased and/or recommended by a user's social circles in order to improve the quality of search results of the search engine 102.

The personalized query-independent scores module 112 may generate a query-independent score based on user demographic signals 450, user's buying/previewing history 451, user's music uploads to a music locker 452, user's interests/attendance of music events 453, and signals 454 associated with user's social circles.

For example, based on a user's past purchases/views, the search engine 102 may determine the genres of songs the user 101 is interested in, which information may be used by the ranker 106 to boost the score of songs and albums that match the user's interests.

Based on a user's viewing history, the ranker 106 may score higher tracks and albums for music videos the user has watched, as well as soundtracks for trailers/movies/videos the user has watched.

Based on audio similarity to tracks the user has purchased/uploaded to a music locker, the ranker 106 may score higher the tracks and albums that are similar to the tracks/albums in their music locker.

Based on understanding user's tastes based on live events such as concerts a user might have attended/checked in to/bought tickets for, the ranker 106 may score higher the tracks and albums that are similar (e.g., similar genre) to the music associated with the live event.

Based on the actions of a user's social circle (purchases and/or +1/likes), the ranker 106 may score higher songs/albums that this user might also like (e.g., songs/albums purchased by the user's social circle friends).

Even though only five query-independent scores modules 450-454 are listed with regard to the personalized query-independent scores module 112, the present disclosure is not limiting in this regard, and other query-independent scores may also be utilized by the search engine 102 in generating the final ranking scores 124, . . . , 126.

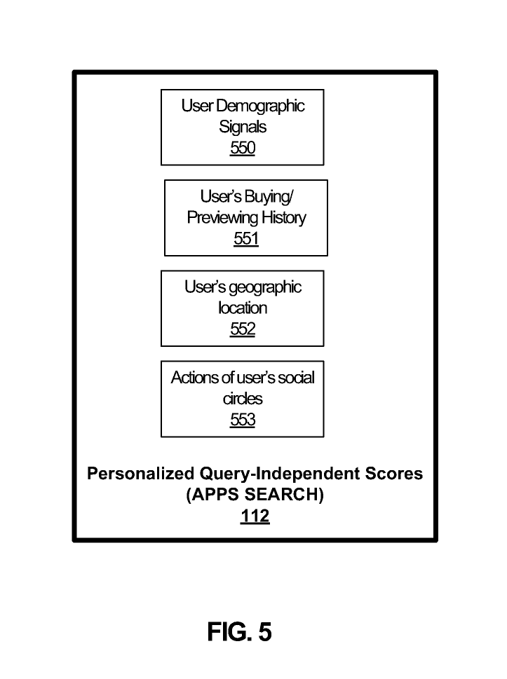

FIG. 5 is a block diagram of an example implementation of a personalized query-independent scores module which may be used in an applications (apps) search engine, in accordance with an example embodiment of the disclosure. Referring to FIGS. 1A-5, in instances when the digital content search engine 102 comprises an apps search engine, the personalized query-independent scores module 112 may use signals from, e.g., a recommendation engine. Such signals may include applications popular in a user's location, applications related to others that the user has already purchased, and applications purchased and/or recommended by a user's social circles in order to improve the quality of search results of the search engine 102.

The personalized query-independent scores module 112 may generate a query-independent score based on user demographic signals 550, user's buying/previewing history 551, user's geographic location 552, and signals 553 associated with user's social circles. The user's geographic location 52 may be derived from user's IP address or based on user input.

For example, the user query 120 may be “Train Schedule.” The search engine 102 may return results such as “Seoul Train Timetable”, “NYC Subway Timings” or “Muni Tracker”. However, the ranker 106 may use user's geographic location information 552 to score higher applications popular in the user's location. In this regard, if the user is in San Francisco, he will receive “BART Schedule” app and “Muni Tracker” app at the top of their results, while users in New York City will receive “NYC Subway Timings” app.

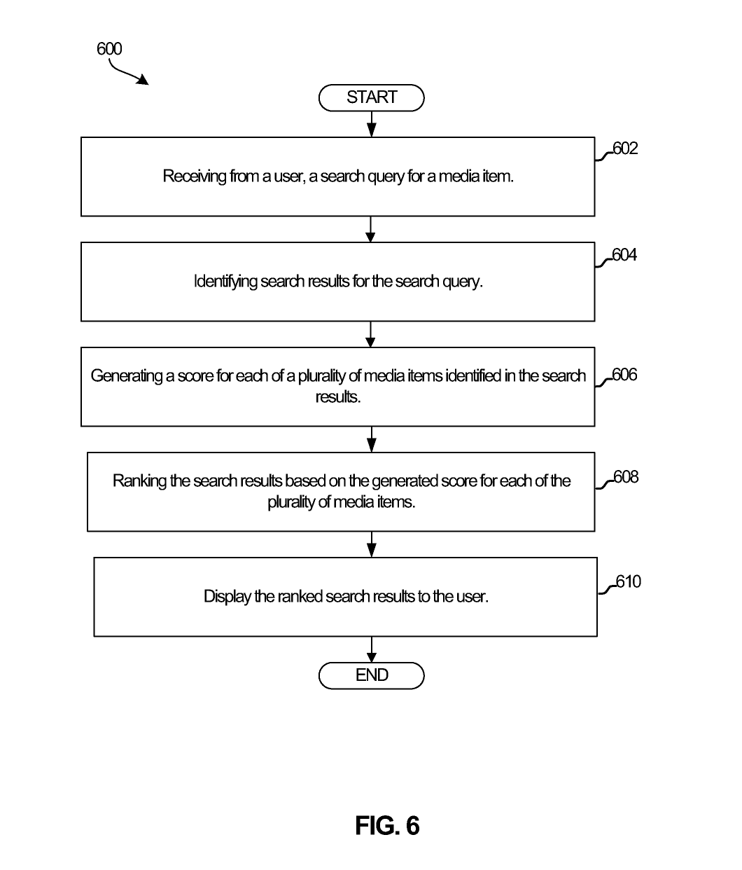

FIG. 6 is a flow chart illustrating example steps of a method for personalizing search results, in accordance with an example embodiment of the disclosure. Referring to FIGS. 1A-6, the example method 600 may start at 602, when the search engine 102 may receive from a user 101, a search query 120 for a media item. At 604, the search engine 102 may identify search results 122 for the search query. At 606, the ranker 106 may generate a score (124, . . . , 126) for each of a plurality of media items identified in the search results (documents D1, . . . , Dn). The score for a corresponding one of the plurality of media items in the search results 122 may be based on a score dependent on the search query (e.g., query dependent score 116) and one or both of at least one personalized query independent score (e.g., 118) and/or at least one personalized query dependent score (e.g., 117).

The at least one personalized query independent score (e.g., 118) and the at least one personalized query dependent score (e.g., 117) may be based on at least one media preference signal associated with the user. The media item may include a video, a movie, a TV show, a book, an audio recording, a device application (app), a music album, and/or another type of digital media item. At 608, the ranker 106 may rank the search results 122 based on the generated score (124, . . . , 126) for each of the plurality of media items. At 610, the ranked search results may be displayed to the user 101.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for personalizing search results.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method for personalizing search results, comprising:
receiving from a user, a search query for a media item;
identifying search results for the search query;
generating a score for each of a plurality of media items identified in the search results, wherein:
the score for a corresponding one of the plurality of media items is based on the search query and one or both of a personalized query independent score and/or a personalized query dependent score; and
the personalized query independent score and the personalized query dependent score are based on at least one media preference signal associated with the user; and
ranking the search results based on the generated score for each of the plurality of media items.

2. The method according to claim 1, wherein the media item comprises one or more of a video, a movie, a TV show, a book, an audio recording, a device application (app), and a music album.

3. The method according to claim 1, wherein if the media item comprises a book, the at least one media preference signal comprises one or more of:
a book-related preference signal associated with user demographics of the user;
a book-related preference signal associated with one or both of previous buying history of the user and previous viewing history of the user; and
a book-related preference signal associated with one or more books popular within at least one social circle of the user.

4. The method according to claim 1, wherein if the media item comprises a music-related item, the at least one media preference signal comprises one or more of:
a music-related preference signal associated with one or both of previous music buying history of the user and previous music video viewing history of the user;
a music-related preference signal associated with one or more music-related items popular within at least one social circle of the user;
a music-related preference signal associated with at least one audio similarity between music tracks previously purchased by the user; and
a music-related preference signal associated with music type of at least one concert event attended by the user.

5. The method according to claim 1, wherein if the media item comprises a movie or a TV show, the at least one media preference signal comprises one or more of:
a movie-related preference signal associated with one or both of previous movie or TV show buying history of the user, and previous movie or TV show viewing history of the user; and
a movie-related preference signal associated with one or more movies or TV shows popular within at least one social circle of the user.

6. The method according to claim 1, wherein if the media item comprises a device application (app), the at least one media preference signal comprises one or more of:
an application-related preference signal associated with popularity of at least one app within user demographics of the user;
an application-related preference signal associated with popularity of at least one app within a geographic location of the user;
an application-related preference signal associated with previous app buying history of the user; and
an application-related preference signal associated with one or more apps popular within at least one social circle of the user.

7. The method according to claim 1, wherein the personalized query independent score is based on popularity of at least one media item among users located in a current geographic location associated with the user.

8. A system for personalizing search results, comprising:
a network device comprising at least one processor coupled to memory, the network device operable to:
receive from a user, a search query for a media item;
identify search results for the search query;
generate a score for each of a plurality of media items identified in the search results, wherein:
the score for a corresponding one of the plurality of media items is based on the search query and one or both of a personalized query independent score and/or a personalized query dependent score; and
the personalized query independent score and the personalized query dependent score are based on at least one media preference signal associated with the user; and
rank the search results based on the generated score for each of the plurality of media items.

9. The system according to claim 8, wherein the media item comprises one or more of a video, a movie, a TV show, a book, an audio recording, a device application (app), and a music album.

10. The system according to claim 8, wherein if the media item comprises a book, the at least one media preference signal comprises one or more of:
a book-related preference signal associated with user demographics of the user;
a book-related preference signal associated with one or both of previous buying history of the user and previous viewing history of the user; and
a book-related preference signal associated with one or more books popular within at least one social circle of the user.

11. The system according to claim 8, wherein if the media item comprises a music-related item, the at least one media preference signal comprises one or more of:
a music-related preference signal associated with one or both of previous music buying history of the user and previous music video viewing history of the user;
a music-related preference signal associated with one or more music-related items popular within at least one social circle of the user;
a music-related preference signal associated with at least one audio similarity between music tracks previously purchased by the user; and
a music-related preference signal associated with music type of at least one concert event attended by the user.

12. The system according to claim 8, wherein if the media item comprises a movie or a TV show, the at least one media preference signal comprises one or more of:
a movie-related preference signal associated with one or both of previous movie or TV show buying history of the user, and previous movie or TV show viewing history of the user; and
a movie-related preference signal associated with one or more movies or TV shows popular within at least one social circle of the user.

13. The system according to claim 8, wherein if the media item comprises a device application (app), the at least one media preference signal comprises one or more of:
an application-related preference signal associated with popularity of at least one app within user demographics of the user;
an application-related preference signal associated with popularity of at least one app within a geographic location of the user;
an application-related preference signal associated with previous app buying history of the user; and
an application-related preference signal associated with one or more apps popular within at least one social circle of the user.

14. The system according to claim 8, wherein the personalized query independent score is based on popularity of at least one media item among users located in a current geographic location associated with the user.

15. A machine-readable storage device, having stored thereon a computer program having at least one code section for personalizing search results, the at least one code section executable by a machine for causing the machine to perform a method comprising:
receiving from a user, a search query for a media item;
identifying search results for the search query;
generating a score for each of a plurality of media items identified in the search results, wherein:
the score for a corresponding one of the plurality of media items is based on the search query and one or both of a personalized query independent score and/or a personalized query dependent score; and
the personalized query independent score and the personalized query dependent score are based on at least one media preference signal associated with the user; and
ranking the search results based on the generated score for each of the plurality of media items.

16. The machine-readable storage device according to claim 15, wherein the media item comprises one or more of a video, a movie, a TV show, a book, an audio recording, a device application (app), and a music album.

17. The machine-readable storage device according to claim 15, wherein if the media item comprises a book, the at least one media preference signal comprises one or more of:
a book-related preference signal associated with user demographics of the user;
a book-related preference signal associated with one or both of previous buying history of the user and previous viewing history of the user; and
a book-related preference signal associated with one or more books popular within at least one social circle of the user.

18. The machine-readable storage device according to claim 15, wherein if the media item comprises a music-related item, the at least one media preference signal comprises one or more of:
a music-related preference signal associated with one or both of previous music buying history of the user and previous music video viewing history of the user;
a music-related preference signal associated with one or more music-related items popular within at least one social circle of the user;
a music-related preference signal associated with at least one audio similarity between music tracks previously purchased by the user; and
a music-related preference signal associated with music type of at least one concert event attended by the user.

19. The machine-readable storage device according to claim 15, wherein if the media item comprises a movie or a TV show, the at least one media preference signal comprises one or more of:
a movie-related preference signal associated with one or both of previous movie or TV show buying history of the user, and previous movie or TV show viewing history of the user; and
a movie-related preference signal associated with one or more movies or TV shows popular within at least one social circle of the user.

20. The machine-readable storage device according to claim 15, wherein if the media item comprises a device application (app), the at least one media preference signal comprises one or more of:
an application-related preference signal associated with popularity of at least one app within user demographics of the user;
an application-related preference signal associated with popularity of at least one app within a geographic location of the user;
an application-related preference signal associated with previous app buying history of the user; and
an application-related preference signal associated with one or more apps popular within at least one social circle of the user.
